(19) United States
(12) Patent Application Publication
(10) Pub. No.: US 2026/0351613 A1
(43) Pub. Date: Nov. 5, 2026

(54) USE OF LIQUID COMPOSITIONS OF CARBON FILLERS

(71) Applicant: Arkema France, Puteaux (FR)

(72) Inventors: Oleksandr KORZHENKO, LACQ (FR); Cathy REY, LACQ (FR); Christophe VINCENDEAU, LACQ (FR)

(73) Assignee: Arkema France, Puteaux (FR)

(21) Appl. No.: 19/488,486

(22) PCT Filed: May 23, 2024
(86) PCT No.: PCT/FR2024/050662

§ 371 Date: Nov. 26, 2025

(30) Foreign Application Priority Data
Jun. 1, 2023 (FR) FR2305496

(51) Int. Cl. H01M 4/62; H01M 4/02

(52) U.S. Cl. CPC H01M 4/625; H01M 2004/021

(57) ABSTRACT

The present invention relates to the use of liquid compositions of carbon-based fillers for the manufacture of electrodes for batteries, more particularly of carbon nanotubes, in which the carbon-based fillers in the liquid composition are present at contents by weight of between 3.5% and 20%.

The present invention relates to the use of liquid compositions of carbon-based fillers for the manufacture of electrodes for batteries, more particularly of carbon nanotubes, in which the carbon-based fillers in the liquid composition are present at contents by weight of between 3.5% and 20%.

### Context and Prior Art

In a Li-ion battery electrode, it is necessary to formulate the electroactive material with additives (electron-conducting agent, polymer binder) in order to provide this layer with the mechanical and electrical properties necessary for its assembling in the battery and for its subsequent satisfactory operation. The formulation requires the combination of additives which is the most appropriate and proportions guaranteeing the best compromise between satisfactory operation of the electrode and a minimum content of additives.

The change in environmental constraints and the processes for the manufacture of electrodes and batteries containing them are imposing conditions which are increasingly sparing in resources with a view in particular to a reduction in the carbon footprint in the context of a life cycle assessment according to the standard ISO 14040 (2006).

Carbon-based fillers are compounds which can take various forms, such as carbon blacks, carbon fibers and nanofibers, graphenes, fullerenes and also carbon nanotubes.

Carbon nanotubes are made of wound graphite sheets, with a diameter which can vary from a few nanometers to a few tens of nanometers. They are provided in the form of single sheets or multisheets.

Carbon-based fillers are used to improve the electrical conductivity of the electrodes of batteries.

As regards the carbon nanotubes obtained in the various synthetic processes, they cannot be directly formulated because they exist the form of entangled balls or bundles. It is the same for the other carbon-based fillers to a lesser extent but often associated with carbon nanotubes; it is the latter which are often the compounds which determine the nature of the conditions necessary for the preparation of dispersions having high contents of carbon-based fillers.

Today, the use of carbon-based fillers in electrodes for batteries and in particular of carbon nanotubes requires dispersing them correctly beforehand in the form of a dispersion in a solvent with specific conditions. The operation is carried out by ultrasonic methods or under shearing in the presence of a dispersant which makes it possible in particular to release the carbon nanotubes from their entanglements but requires large amounts of solvent. Given the small amounts of carbon nanotubes present in these dispersions, it is consequently necessary to transport large amounts of material between the sites of production of carbon nanotubes and of their dispersion and the users, generating a very unfavorable carbon footprint. In the known prior art, dispersions having contents of carbon nanotubes always of less than 5% and rather in the vicinity of 1%, accompanied by high viscosities, are reported. The small amount of carbon-based fillers present in the dispersions is a limitation on the use of these dispersions in electrodes since current processes for the manufacture of electrodes seek to limit as much as possible the presence of solvent with as ultimate objective the preparation of solvent-free electrodes (dry process).

Thus, EP 2 550 699 describes the preparation of liquid compositions of carbon nanotubes. However, the contents of carbon nanotubes in the solvent remain low, of the order of 2%.

In EP 3 786 110, a content of carbon nanotubes of at most 5% with high viscosities of the dispersions is reported in the examples. In point of fact, the concentration of carbon nanotubes and the viscosity of the dispersions of carbon nanotubes is a limiting factor for their use.

A first technical problem consists in searching for solutions which make it possible to incorporate as much as possible of carbon-based fillers and in particular of carbon nanotubes in a solvent because it is this which exhibits the best carbon footprint.

A second technical problem consists in finding solutions which make it possible for these compositions to remain liquid over time because, if a composition can be obtained liquid on conclusion of the manufacturing stage, it should remain so as far as its final destination, making possible easy decanting after its storage or its transportation to the final use, which is not always the case for one and the same content of carbon nanotubes according to the solvent and dispersant pair used. The presence of other carbon-based fillers combined with the carbon nanotubes only exacerbates the difficulties.

A third technical problem is the temperature stability of the viscosity, since the manufacture, the storage and the use of these compositions have to tolerate temperature differences.

The solutions which can be provided to solve these technical problems are generally studied and characterized by rheology measurements. Unfortunately, the presence of carbon-based fillers and in particular the presence of carbon nanotubes largely masks the characteristics of the solvents and dispersants which are necessary to solve these technical problems. This is why the applicant company has studied more particularly the rheological behaviors of dispersant-solvent pairs in the absence of carbon-based fillers since it is these pairs which make it possible to predict the possibility of having available compositions having high contents of carbon-based fillers.

The applicant company has discovered that such compositions having a high content of carbon-based fillers solving these three technical problems are obtained when the rheological behavior of the dispersant-solvent pair obeys certain solubility conditions and remains newtonian within the meaning of the standard ISO 3219-1:2021, that is to say that the dispersant-solvent pair must exhibit a behavior in which the shear viscosity is independent of the shear rate, of the shear stress and of the time in the shear range 0-150 s⁻¹ while remaining less than 1 Pa·s at shearing of 0.1 s⁻¹.

Such conditions are governed by the choice of the solvent-dispersant pair. The rheological behavior of the solvent-dispersant pair is more representative of the dispersion of the carbon-based fillers in the solution of dispersant and of solvent because it makes it possible to select the conditions making possible a stable dispersion over time of the carbon-based fillers at a high content in a solvent, typically above 5%.

When the right conditions are brought together, it is possible to obtain liquid compositions of carbon nanotubes exhibiting contents by weight which can range up to 20%. A measurement of the Dv50 of less than 50 nm attests to the satisfactory dispersion of the carbon nanotubes within these compositions. With a combination of carbon nanotubes and of carbon black, the Dv50 remains low with values of less than 600 nm. The compositions used in the invention remain stable over time, including with regard to temperature.

These conditions are met when the dispersant has a solubility of greater than 15% in the solvent, on the one hand, and when, on the other hand, the solvent-dispersant mixture at a content of greater than 15% of dispersant exhibits a dynamic viscosity at 0.1 s⁻¹ of less than 1 Pa·s, accompanied by a newtonian behavior in the 0-150 s⁻¹ shear range. With these rheological conditions of the solvent-dispersant pair, an optimal range linking the viscosity and the content of carbon-based fillers in a dispersion of carbon-based fillers, of solvent and of dispersant can be identified.

In other words, if the dispersant is insufficiently soluble in the chosen solvent, that is to say that it exhibits a solubility by weight of less than 15%, it is not possible to obtain dispersions having high contents of carbon-based fillers. With the compositions used in the invention, it is now possible to respond to changes in the process for the manufacture of electrodes requiring less solvent and with compositions which are stable over time.

### SUMMARY OF THE INVENTION

The invention relates to the use of a composition for the formulation of electrodes, this composition comprising:
carbon-based fillers in proportions by weight of between 3.5% and 20% of the composition, which fillers are chosen from carbon nanotubes and/or carbon blacks,
at least one solvent, chosen from water, N-alkylpyrrolidones, such as N-methylpyrrolidone, dimethyl sulfoxide, alkyl carbonates, Cyrene™, dimethylformamide, acetates, furans or alcohols,
at least one dispersant, chosen from polyvinylpyrrolidone homopolymers or copolymers, polyvinyl alcohol homopolymers or copolymers, polyacrylic acid homopolymers or copolymers comprising acrylic acid, polyacrylonitriles, polynitrile homopolymers and copolymers, linear polyesters or polyethers, or polycarboxylate ethers, alone or in combination, in which the solubility of the dispersant is greater than 15% by weight in the solvent alone and the mixture of which with the solvent alone exhibits the following two conditions when it is dissolved at a content of greater than 15% by weight:
a dynamic viscosity at 0.1 s⁻¹<1 Pa·s,
a newtonian behavior in the gradient range 0-150 s⁻¹,
   said composition exhibits a carbon-based fillers/dispersant ratio by weight of between 10/1 and 1/1, preferably between 5/1 and 3/1, and a pH of between 5 and 13.

### DETAILED DESCRIPTION

By newtonian behavior within the meaning of the standard ISO 3219-1:2021, it is considered that the dispersant-solvent pair must exhibit a behavior in which the shear viscosity is independent of the shear rate, of the shear stress and of the time in the shear range 0-150 s⁻¹, with a maximum variation in the viscosity in the shear range 0-150 s⁻¹ of 10%.

The carbon-based fillers used in the context of the invention can be carbon nanofibers, synthetic graphite, graphite nanosheets, graphite nanoplatelets, graphene sheets, nonsynthetic graphite, natural graphite, coke, graphitized carbon nanofibers, carbon nanotubes or their combinations. The carbon nanotubes are multiwall, the diameter of which is of between 8 and 50 nm and preferably between 8 and 20 nm (measured by transmission electron microscopy). The carbon nanotubes exhibit a specific surface, measured by BET with an appliance of ASAP 2460 type from Micrometrics, of between 120 and 450 m²/g and preferably between 150 and 300 m²/g. They can be obtained by any type of process and exist, on conclusion of their synthesis, in entangled form, bundles or a combination of the two. The carbon nanotubes can be purified, that is to say freed of the metal catalysts necessary in their synthesis. The term “purified carbon nanotubes” is understood to mean carbon nanotubes, the metal content of which is less than 200 ppm and preferably less than 50 ppm by a heat treatment under a neutral atmosphere and at a temperature of greater than 200 °C with a treatment time which is variable according to the temperature generally of between 30 minutes and 3 hours. The carbon nanotubes can also be functionalized. The carbon nanotubes which have undergone a heat treatment under a neutral or reducing atmosphere or under a partial pressure of less than 0.8 Pa and at a temperature of greater than 200 °C constitute an alternative form of the invention. This heat treatment can also be obtained by compacting the carbon nanotubes during the operation of drying the compacted carbon nanotubes, for example in the presence of water.

The use of the compositions of the invention in processes for the manufacture of electrodes thus makes it possible to use less solvent because the carbon-based fillers in liquid dispersions are present at contents by weight of between 3.5% and 20%, preferably between 5% and 14%, in a preferred way between 5% and 11%, in a preferred way between 6% and 10% and more preferably still between 6% and 8%. Moreover, the use of the compositions of the invention is possible after prolonged storage for one month, whether this is at ambient temperature or at 60 °C.

Preferably, the carbon-based fillers used in the compositions of the invention consist of carbon nanotubes and/or of carbon black. When carbon black in combination with carbon nanotubes is concerned, the carbon nanotubes/carbon black ratios by weight can vary from 100/1 to 1/100, preferably from 100/5 to 1/5. Preferably, graphenes are excluded from the compositions of the invention.

The specific surface of the carbon blacks is less than 2000 m²/g, preferably less than 1000 m²/g, in a preferred way less than 200 m²/g, and a particle size of less than 50 μm, measured by a Malvern Mastersizer 3000.

Moreover, the fact of being able to disperse a combination of carbon nanotubes and of carbon black at a high content in one and the same dispersion makes possible an additional gain in solvent economy and a better performance of the electrodes in the batteries. To date, these two carbon-based fillers have been introduced separately and less intimately within the electrodes.

During the operation of dispersion of the carbon-based fillers with a solvent and a dispersant, any type of process can be used. This can be by ultrasound, extrusion, multiple extrusion, kneading, grinding in a suitable mill, such as a bead mill, or a combination of these processes.

The solvent can be one solvent or a mixture of solvents. Subsequently, the term “solvent”, which includes the mixtures of solvents, will be used. The solvent is chosen from water, N-alkylpyrrolidones, N-methylpyrrolidone, dimethyl sulfoxide, alkyl carbonates, Cyrene™, dimethylformamide, acetates, furans, alcohols and their mixtures. Preferably, it is N-methylpyrrolidone. The N-methylpyrrolidone can be pure or result from a recycling or reuse process not comprising a distillation stage. It would not be departing from the scope of the invention with a solvent consisting predominantly of one of the solvents listed above and of a cosolvent not listed above.

The dispersants are chosen from polyvinylpyrrolidone homopolymers or copolymers, polyvinyl alcohol homopolymers or copolymers, polyacrylic acid homopolymers or copolymers comprising acrylic acid, polyacrylonitriles, polynitrile homopolymers and copolymers, linear polyesters or polyethers, ether polycarboxylates, alone or in combination, and more particularly polyvinylpyrrolidone homopolymers or copolymers and more preferably polyvinylpyrrolidone homopolymers or copolymers, the weight-average molecular mass of which is of between 20 000 and 30 000 g/mol. The polyacrylic acid homopolymers or copolymers comprising predominantly acrylic acid can be used in the form of their alkaline salts, preferably Li⁺ or Na⁺ salts. Subsequently, the term “dispersant” will be used, it being possible for the dispersant to be composed alone or a mixture of dispersants of different natures or of the same nature but with different molecular characteristics (molecular weights, dispersity, polydispersity).

It is considered that the dispersant can be a single dispersant or a mixture of dispersants. The presence of surfactants or other additives can also be envisaged. Thus, the dispersant can be a dispersant or mixture of dispersants in the presence of at least one surfactant and/or other additive.

The carbon-based fillers/dispersant ratio by weight is of between 10/1 and 1/1 and preferably between 5/1 and 2/1 within the compositions of the invention. The dispersant and the solvent exhibit the following combined characteristics:
the dispersant must be soluble in the solvent at contents by weight of greater than 15% (condition A),
the dispersant-solvent mixture according to condition A must exhibit a dynamic viscosity at 0.1 s⁻¹ of less than 1 Pa·s for a content by weight of more than 15% in the solvent (condition B),
the dispersant-solvent mixture must exhibit a newtonian behavior in the gradient range of between 0 and 150 s⁻¹ and with a dynamic viscosity of less than 1 Pa·s (condition C).

The term “solubility of greater than 15% by weight” is understood to mean the possibility of dissolving more than 15 g of dispersant per 100 g of solution at temperatures of between 15 °C and 25 °C.

The measurement of the solubility of the dispersant in the solvent makes possible a selection according to criterion A. It is considered that the maximum of dispersant which can be dissolved in a solvent is the concentration above which a cloudiness appears.

The measurement of the viscosity at the shear of 0.1 s⁻¹ of the dispersant-solvent pair makes it possible to confirm that the value of 1 Pa·s is not exceeded (criterion B).

The measurement of dispersant-solvent pair viscosity in the shear range between 0 and 150 s⁻¹ makes it possible to confirm that the behavior is newtonian with a viscosity of less than 1 Pa·s (criterion C).

The three criteria can be confirmed by taking two measurements within the scope of a person skilled in the art, that of the solubility in the solvent and the establishment of the rheological curve of the viscosity as a function of the shearing using a rheometer, according to the standard ISO 3219-2:2021.

The general approach is given in FIG. 7.

The measurements of viscosity of the dispersant-solvent pairs show that the pairs selected in the context of the invention satisfy the following inequation (FIG. 5):

Y<0.0006^{e0.2399X}

where Y is the viscosity at 0.1 s⁻¹ in Pa·s and X is the content by weight in % of dispersant.

The measurement of the viscosities in the presence of carbon-based fillers show that the dispersions of the invention satisfy the following inequation (FIG. 6):

Y1<0.0024e^{1.2531X1}

where Y1 is the viscosity at 0.1 s⁻¹ in Pa·s and X1 is the content by weight in % of carbon-based fillers.

Other adjustments are necessary when it is desired to obtain high contents of carbon nanotubes. Thus, it turned out that a basic pH promotes high contents of carbon-based fillers. For these high contents, it is favorable for the compositions of the invention to exhibit a pH of between 5 and 13.5, preferably between 7 and 12, in a preferred way between 8 and 11 and more preferably between 9 and 11. The pH can be adjusted using an inorganic or organic base, among which may be mentioned, in a nonlimiting way, sodium hydroxide, potassium hydroxide, lithium hydroxide, sodium carbonate, potassium carbonate, lithium carbonate or amines. Preferably, it concerns sodium hydroxide, lithium hydroxide, sodium carbonate or lithium carbonate.

During the use of the compositions of the invention to formulate an electrode, it will be advisable to add the necessary compounds (active material, polymer binder, other additives). A pH adjustment can be carried out for the shaping of the electrode.

The invention also relates to an electrode using the compositions of the invention. The electrode can be a cathode or an anode.

The invention also relates to a battery comprising at least one electrode (anode or cathode) obtained by the use of the compositions of the invention.

### DESCRIPTION OF THE FIGURES

FIG. 1: Couette geometry used for the rheology measurements.

FIG. 2: Viscosity curve—flow of CMC in water.

FIG. 3: Viscosity curve—flow of PVP1 in water.

FIG. 4: Viscosity curve—flow of PVP2 in water.

FIG. 5: Viscosity of the dispersant-water solutions as a function of the content as % by weight of dispersant.

FIG. 6: Viscosity of the dispersions as a function of the content as % by weight of carbon-based fillers.

FIG. 7: Flow chart for the selection of the dispersant-solvent pairs.

### EXAMPLES

Products used for the study and the preparation of the dispersions: Carbon-based fillers:
Carbon nanotubes (CNT1): provenance Arkema grade Graphistrength® C100. CNT1 are carbon nanotubes of entangled type.
Carbon nanotubes (CNT2): prepared according to EP 1 846 157 but using an aluminosilicate catalyst support. CNT2 are bundle-type carbon nanotubes.
CNT3 are carbon nanotubes of CNT1 type having undergone a heat treatment at a temperature of greater than 200 °C for 2 hours.
Carbon black (CB): provenance Imerys grade Super P® Li.

### Solvents:

Demineralized water.
N-Methylpyrrolidone, NMP.

### Dispersants:

Carboxymethylcellulose (CMC): provenance and grade Finnfix® 2G.
Polyvinylpyrrolidone (PVP1): provenance Sigma-Aldrich® reference 234257 with a weight-average molecular mass of 29 000 g/mol.
Polyvinylpyrrolidone (PVP2): provenance Nippon Shokubai K-85W with a weight-average molecular mass of 85 000 g/mol.
Polyacrylic acids: Polycarboxylate: provenance Coatex, grade Ethacryl HF 50.
PVDF: provenance Arkema Kynar® 761.
Hydrogenated nitrile rubber: provenance Lanxess grade Therban® AT 3404.
Water-soluble lignin: provenance Sigma-Aldrich® grade 370959.
pH adjuster: Sodium hydroxide NaOH: provenance Sigma-Aldrich®

### Conditions of the Rheological Measurements:

A controlled-stress rheometer of MCR301 type from Anton Paar is used. The standard used is ISO 3219-2:2021.

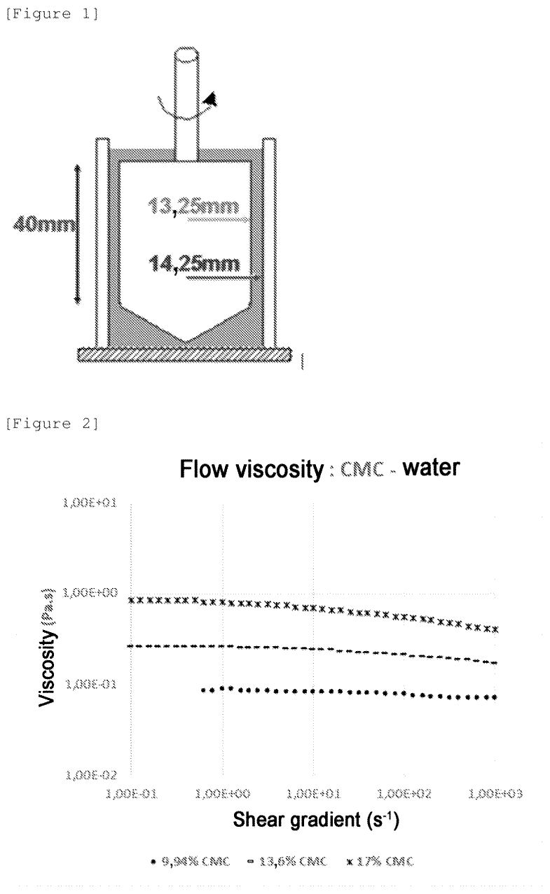

The measurements are carried out by flow stress sweeping at 20 °C. The geometry used is of Couette type for which the temperature regulation is provided by the Peltier effect. The Couette geometry used is given in FIG. 1. The composition to be studied is introduced into the gap of the Couette geometry using a disposable pipette. The shear gradient range varies logarithmically from 0.1 to 1000 s⁻¹ with measurement of 10 points per period of 10 days.

Example 1: Study of the dispersant-solvent pairs and rheological measurements: The solutions of dispersant in the solvent are prepared by dissolution at 20 °C in a device, such as a beaker, in the presence of stirring, with the compositions given in table 1.

The rheology measurements are carried out and the criteria, met or not met, A, B and C are reported in table 1.

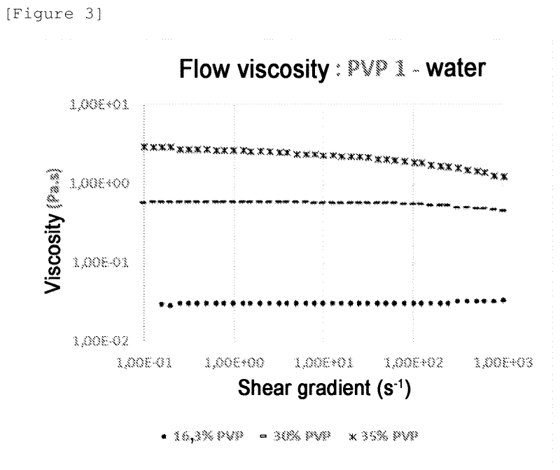

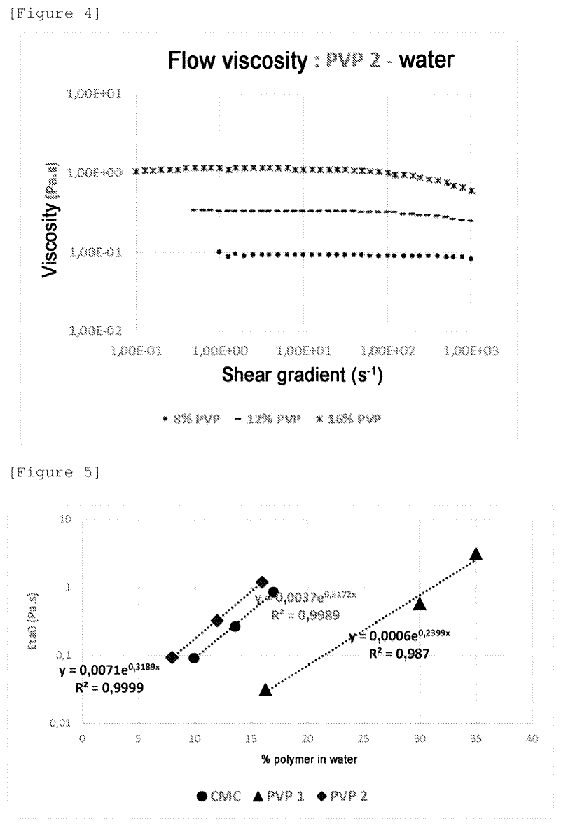

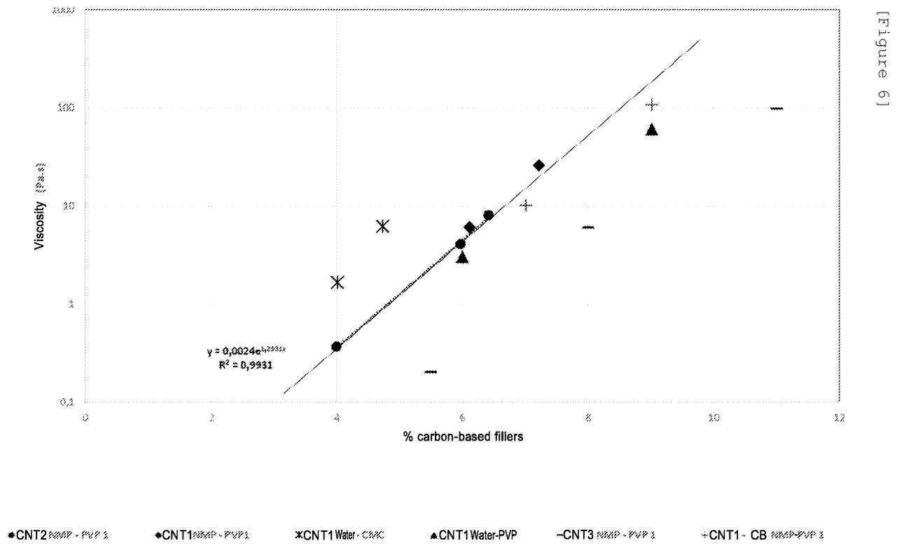

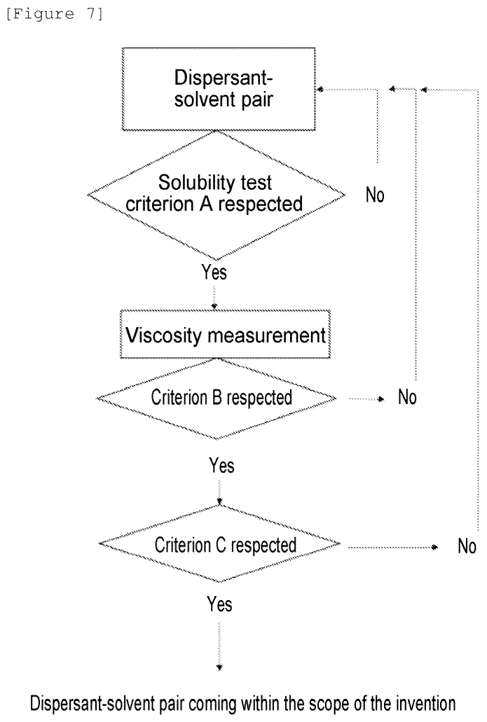

By way of illustration, the rheological behaviors of certain dispersant-solvent pairs are reported in FIGS. 2, 3 and 4.

TABLE 1

| | | | % by weight | | | | |
|---|---|---|---|---|---|---|---|
| | | | dispersant/ | Condi- | Condi- | Condi- | |
| | Solvent | Dispersant | solvent | tion A | tion B | tion C | Figure |
| 1.1 | Water | CMC | 9.94 | no | yes | yes | 2 |
| 1.2 | Water | CMC | 13.6 | no | yes | yes | 2 |
| 1.3 | Water | CMC | 17 | yes | yes | no | 2 |
| 1.4 | Water | PVP 1 | 16.3 | yes | yes | yes | 3 |
| 1.5 | Water | PVP 1 | 30 | yes | yes | yes | 3 |
| 1.6 | Water | PVP 1 | 35 | yes | yes | no | 3 |
| 1.7 | Water | PVP 2 | 8 | no | yes | yes | 4 |
| 1.8 | Water | PVP 2 | 12 | no | yes | yes | 4 |
| 1.9 | Water | PVP 2 | 16 | yes | yes | no | 4 |
| 1.10 | Water | Polycarboxylate | 30 | yes | yes | yes | |
| 1.10 | Water | Polycarboxylate | 50 | yes | yes | no | |
| 1.11 | Water | Water- | 6 | no | yes | yes | |
| | | soluble lignin | | | | | |
| 1.12 | NMP | Hydrogenated | 10 | no | yes | no | |
| | | nitrile rubber | | | | | |
| 1.13 | NMP | PVDF | 11 | no | no | no | |
| 1.14 | NMP | PVP1 | 35 | yes | yes | no | |
| 1.15 | NMP | PVP1 | 20 | yes | yes | yes | |
| 1.16 | NMP | PVP2 | 8 | no | yes | yes | |
| 1.17 | NMP | PVP2 | 16 | yes | yes | no | |

### Example 2

In this series of examples, the behavior of the dispersions of carbon-based fillers in dispersant-solvent pairs is studied.

The dispersions of carbon-based fillers in a solvent in the presence of dispersant are produced according to the method described in examples 7 and 8 of EP 2 550 699 describing the case for the dispersant-solvent pair CMC-water.

The same procedure is used to prepare the dispersions according to the examples of table 2. The rheology measurements are taken immediately after preparation of the dispersions and also at the end of 1 month at ambient temperature and at 60 °C. The Dv50 is measured immediately after preparation of the dispersions and also at the end of 1 month using an appliance of Malvern Mastersizer 3000 type.

The results are given in table 2.

TABLE 2

| | | | Ratio by | | | | |
|---|---|---|---|---|---|---|---|
| | | | weight | | | | |
| | | | dispersant/ | | | | |
| | | Dispersant- | carbon-based | | | | |
| | | solvent pair | fillers | % CNT1 | % CNT2 | % CNT3 | % CB |
| outside the | 2.1 | CMC/Water | 1/3 | 4.3 | 0 | | 0 |
| invention | | | | | | | |
| invention | 2.2 | PVP1/Water | 1/4 | 9 | 0 | | 0 |
| invention | 2.3 | PVP1/Water | 1/4 | 6 | 0 | | 0 |
| outside the | 2.4 | PVP2/Water | 1/4 | 3.5 | 0 | | 0 |
| invention | | | | | | | |
| invention | 2.5 | PVP1/NMP | 1/4 | 6.12 | 0 | | 0 |
| invention | 2.6 | PVP1/NMP | 1/4 | 7.216 | 0 | | 0 |
| invention | 2.7 | PVP1/NMP | 1/4 | 0 | 6.416 | | 0 |
| invention | 2.8 | PVP1/NMP | 1/4 | 0 | 5.98 | | 0 |
| invention | 2.9 | PVP1/NMP | 1/4 | 0 | 4 | | 0 |
| invention | 2.10 | PVP1/NMP | 1/4 | 0 | 0 | 5.5 | 0 |
| Invention | 2.11 | PVP1/NMP | 1/4 | 0 | 0 | 8 | 0 |
| invention | 2.12 | PVP1/NMP | 1/4 | 0 | 0 | 11 | 0 |
| invention | 2.23 | PVP1/NMP | 1/4 | 11 | 0 | | 0 |
| invention | 2.14 | PVP1/NMP | 1/9 | 2.3 | | | 4.7 |
| invention | 2.15 | PVP1/NMP | 1/9 | 3 | | | 6 |
| invention | 2.16 | Ethacryl HF | 1/3 | 7 | 0 | | 0 |
| | | 50/Water | | | | | |
| invention | 2.17 | Ethacryl HF | 1/3 | 5 | 0 | | 0 |
| | | 50/Water | | | | | |
| outside the | 2.18 | Hydrogenated | 1/4 | 3 | | | |
| invention | | nitrile | | | | | |
| | | rubber/NMP | | | | | |
| outside the | 2.19 | PVDF/NMP | 1/4 | 3 | | | |
| invention | | | | | | | |

| | | | Viscosity | Viscosity | | |
|---|---|---|---|---|---|---|
| | | | t + 1 month | t + 1 month | | |
| | | Viscosity | Pa · s | Pa · s | | Dv50 |
| | | t0 Pa · s | at 1 s − 1 | at 1 s − 1 | Dv50 t0 | t + 1 |
| | pH | 23 °C | 23 °C | 60 °C | (nm) | month(nm) |
| outside the | 8.6 | 0.5 | 28 | not measurable | <50 | <50 |
| invention | | | | as too high* | | |
| invention | 9.1 | 0.3 | 16 | 33 | <50 | <50 |
| invention | 9.1 | 0.1 | 1.46 | 1.8 | <50 | <50 |
| outside the | 9.1 | 3 | >40 | not measurable | >500 | >500 |
| invention | | | | as too high* | | |
| invention | 9.8 | 0.3 | 2.35 | 3.44 | <50 | <50 |
| invention | 9.8 | 0.4 | 6.19 | 22 | <50 | <50 |
| invention | 9.8 | 0.4 | 3.29 | 18 | <50 | <50 |
| invention | 9.8 | 0.25 | 1.91 | 12 | not | not |
| | | | | | measured | measured |
| invention | 9.8 | 0.1 | 0.19 | 0.8 | not | not |
| | | | | | measured | measured |
| invention | 9.1 | 0.05 | 0.17 | 0.21 | not | not |
| | | | | | measured | measured |
| Invention | 9.5 | 0.35 | 2.73 | 7.5 | not | not |
| | | | | | measured | measured |
| invention | 10.1 | 0.7 | 22.3 | 28 | not | not |
| | | | | | measured | measured |
| invention | 9.8 | 0.8 | 22.3 | 29 | <50 | <50 |
| invention | 9.3 | 0.4 | 4.12 | 5.2 | <600 | <600 |
| invention | 9.3 | 0.6 | 24.8 | 35 | <500 | <600 |
| invention | 7.9 | 0.55 | 11.4 | not | <50 | <50 |
| | | | | measured | | |
| invention | 7.9 | 0.3 | 2.5 | not | <50 | <50 |
| | | | | measured | | |
| outside the | 7.1 | 1.2 | >40 | not measurable | <100 | <100 |
| invention | | | | as too high* | | |
| outside the | 7 | 0.9 | >40 | not measurable | <100 | <100 |
| invention | | | | as too high* | | |

*with the use of the rotor in FIG. 1.

It can be observed that the examples outside the invention exhibit low contents of carbon-based fillers, in the vicinity of 3-4%, which constitute the maximum making possible the preparation of dispersions with a sufficiently low Dv and of acceptable viscosity. Beyond these contents, it is not possible to obtain dispersions exhibiting satisfactory characteristics.

Moreover, for these examples outside the invention, it is observed that the viscosity increases more significantly with time. When the storage temperature is 60 °C, the viscosity can no longer be measured with the rotor used in FIG. 1.

The examples of the invention show contents of carbon-based fillers which can range up to 11% (example 2.12).

In all cases, the viscosity of the compositions of the invention remains low or moderate, and does not change significantly, including when the compositions remain at 60 °C for one month. The effect of the heat treatment on the viscosity of the compositions is particularly great (examples 2.10, 2.11, 2.12 and FIG. 6).

Thus, compared with the conventional formulations containing less than 3% of carbon-based fillers, the compositions having a high content of carbon-based fillers make it possible to make use of the processes for the manufacture of electrodes with a more favorable environmental footprint.

### Example 3—Manufacture of Electrodes and Measurement of their Performance Qualities

In this example, the electrical performance in a formulation for an electrode of the cathode type is measured.

Cathodes are manufactured with the dispersions immediately after having prepared the dispersions (2.13a and 2.18a), then with the dispersions which have been stored for 1 month at 23 °C (2.13b and 2.18b) and finally with the dispersions which have been stored for 1 month at 60 °C (2.13c and 2.18c).

A series of cathodes which have been manufactured with dispersions which have been stored differently in time and in temperature is thus obtained.

A solution of PVDF (Kynar® HSV 1810 (Arkema)) at 8% in NMP in an amount of 12.5 g was mixed with 4 g of the dispersion of example 2.13a, 2.13b or 2.13c using a disk mixer, at 400 rpm. After mixing for 15 min, 98.5 g of NMC 622 and 10 g of additional NMP are gradually added.

Subsequently, the dispersion is applied to a polyethylene terephthalate (PET) support with a thickness of 100 μm using a doctor blade, targeting a coating thickness of 120 μm. The coating is dried in a ventilated oven at 130 °C for 30 min. The cathodes C213a, C213b and C213c are thus obtained.

The coated PET sheet is cut up in order to obtain the 3×4 cm samples. The ends of each sample are coated with a silver-laden conductive ink. The electrical resistivity was measured using a Keithley brand electrometer.

The same protocol is applied in order to obtain the cathodes with the dispersions of examples 2.18a, 2.18b and 2.18c, the amounts of dispersion being adjusted in order to obtain the same contents of carbon-based fillers as for the C213 series. The cathodes C218a, C218b and C218c are thus obtained.

The results of the electrical measurements are summarized in table 3.

TABLE 3

| | Cathode | Resistivity (Ohm · cm) |
|---|---|---|
| invention | C213a | 45 |
| invention | C213b | 45 |
| invention | C213c | 48 |
| comparative | C218a | 46 |
| comparative | C218b | 55 |
| comparative | C218c | 70 |

If, for dispersions used immediately after their preparation, the cathodes show similar resistivities, it should be noted that those of the invention made possible the use of dispersions having 11% of carbon nanotubes, as opposed to 3% for the comparative example. When the dispersions are used after storage for one month, the advantage of the dispersions of the invention is clear with regard to the dispersions of the comparative example.

Thus, not only does the invention make possible the use of dispersions of carbon-based fillers with less solvent but it makes it possible to also use them after storage for one month at ambient temperature or at 60 °C while retaining their initial quality.

1. A composition for the formulation of electrodes, said composition comprising:
carbon-based fillers in proportions by weight of between 3.5% and 20% of the composition, which fillers are selected from the group consisting of carbon nanotubes and/or carbon blacks,
at least one solvent, selected from the group consisting of water, N-alkylpyrrolidones, dimethyl sulfoxide, alkyl carbonates, Cyrene™ dimethylformamide, acetates, furans and alcohols,
at least one dispersant, selected from the group consisting of polyvinylpyrrolidone homopolymers or copolymers, polyvinyl alcohol homopolymers or copolymers, polyacrylic acid homopolymers or copolymers comprising acrylic acid, polyacrylonitriles, polynitrile homopolymers and copolymers, linear polyesters or polyethers, and polycarboxylate ethers, alone or in combination,
in which the solubility of the dispersant is greater than 15% by weight in the solvent alone and the mixture of which with the solvent alone exhibits the following two conditions when it is dissolved at a content of greater than 15% by weight:
a dynamic viscosity at 0.1 s⁻¹<1 Pa·s,
a Newtonian behavior in the gradient range 0-150 s⁻¹,
said composition exhibits a carbon-based fillers/dispersant ratio by weight of between 10/1 and 1/1, preferably between 5/1 and 3/1, and a pH of between 5 and 13.

2. The composition as claimed in claim 1, in which the solvent is water or N-methylpyrrolidone.

3. The composition as claimed in claim 1, in which the solvent is N-methylpyrrolidone resulting from a recycling or reuse process not comprising a distillation stage.

4. The a composition of claim 1, in which the dispersant is selected from the group consisting of polyvinylpyrrolidone homopolymers or copolymers, the weight-average molecular mass of which is of between 20 000 and 30 000 g/mol, homopolymers or copolymers comprising acrylic acid, linear polyesters or polyethers, and polycarboxylate ethers.

5. The composition of claim 1, in which the carbon-based fillers are selected from the group consisting of multiwall carbon nanotubes, the diameter of which can vary from 8 to 50 nm (measured by transmission electron microscopy), and a BET specific surface of between 120 and 450 m²/g and which have undergone a heat treatment at a temperature of greater than 200 °C or not, carbon blacks, the BET specific surface of which is less than 2000 m²/g and a particle size of less than 50 μm, measured by Malvern Mastersizer 3000, graphenes, and combinations thereof.

6. An electrode obtained from a composition as claimed in claim 1.

7. A battery comprising at least one electrode as claimed in claim 6.
